(19) United States
(12) Patent Application Publication
(10) Pub. No.: US 2013/0183060 A1
(43) Pub. Date: Jul. 18, 2013

(54) IMAGE FORMING APPARATUS

(71) Applicants: Il Kwon KANG, Suwon-si (KR); Hwan Jin YOON, Suwon-si (KR); Jeong Jae SEONG, Namyangju-si (KR)

(72) Inventors: Il Kwon KANG, Suwon-si (KR); Hwan Jin YOON, Suwon-si (KR); Jeong Jae SEONG, Namyangju-si (KR)

(73) Assignee: SAMSUNG Electronics Co., Ltd., Suwon-si (KR)

(21) Appl. No.: 13/740,336

(22) Filed: Jan. 14, 2013

(30) Foreign Application Priority Data
Jan. 16, 2012 (KR) 10-2012-0004838

(51) Int. Cl. G03G 21/20

(52) U.S. Cl. CPC G03G 21/20
USPC 399/92; 399/94

(57) ABSTRACT

An image forming apparatus includes a developing unit to form a visible image on a printing medium using developer, a fixing device to fix the developer to the printing medium, and a heat plate placed between the developing unit and the fixing device such that heat generated from the fixing device is absorbed by the heat plate, and transmission of heat to the developing unit is restricted.

### CROSS-REFERENCE TO RELATED APPLICATIONS

This application claims priority under 35 U.S.C. §119 from Korean Patent Applications No. 2012-0004838, filed on Jan. 16, 2012 in the Korean Intellectual Property Office, the disclosure of which is incorporated herein by reference in its entirely.

### BACKGROUND OF THE INVENTION

1. Field of the Invention

Embodiments of the present general inventive concept relate to an image forming apparatus which includes a developing unit to develop a visible image on a printing medium using developer, and a fixing device to fix the developer image to the printing medium.

2. Description of the Related Art

Generally, image forming apparatuses are devised to form an image on a printing medium. Examples of image forming apparatuses include printers, copiers, fax machines, and devices combining functions thereof.

An image forming apparatus includes a developing unit to transfer a visible image, which has been developed using developer, to a printing medium, an exposure device to form an electrostatic latent image on a photoconductor of the developing unit by irradiating light to the photoconductor of the developing unit, and a fixing device to fix the developer image to the printing medium by applying heat and pressure thereto.

The image forming apparatus has an internal configuration in which the developing unit and the fixing device are arranged close to each other. As described above, however, the fixing device generates heat, and may cause decomposition of developer included in the developing unit when heat generated from the fixing device is transmitted to the developing unit.

The developing unit includes a charging device to charge the photoconductor via corona discharge. An operation of the charging device may inevitably generate discharge byproducts, such as ozone, nitrogen oxide, and the like. The discharge byproducts may contaminate the photoconductor that is arranged close to the charging device.

### SUMMARY OF THE INVENTION

The present general inventive concept provides an image forming apparatus to restrict transmission of heat generated from a fixing device to a developing device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image forming apparatus including a developing unit to form a visible image on a printing medium using developer, a fixing device to fix the developer image to the printing medium, and a heat plate placed between the developing unit and the fixing device.

The heat plate may include a shield section located between the developing unit and the fixing device, and a radiator section integrally extending from the shield section, the radiator section being cooled via heat exchange with air.

The heat plate may further include a connecting section to connect the shield section and the radiator section to each other.

The image forming apparatus may further include a blowing device to allow the radiator section to be cooled in contact with air.

The image forming apparatus may further include a main body defining an external appearance of the image forming apparatus, and the blowing device may include a blowing fan, a suction duct having a width equivalent to a width of the developing unit, into which air is suctioned from the developing unit, a connection duct to connect the suction duct and the blowing fan to each other, and a discharge duct to guide the air discharged from the blowing fan to an outside of the main body.

The radiator section may be located within the suction duct and be cooled by the air passing through the suction duct.

The developing unit may include a photoconductor, and a charging device to charge the photoconductor, and the blowing device may be configured to suction discharge byproducts generated from the charging device and discharge the discharge byproducts to the outside of the main body.

The suction duct may have a suction port at a position corresponding to the charging device, and the developing unit may include a developing housing provided with a discharge port at a position corresponding to the suction port, and the charging device may be located inside the discharge port of the developing housing.

The charging device may include a first electrode having a lattice shape, one surface of the first electrode being spaced apart from the photoconductor so as to face the photoconductor, and a second electrode having a pin shape, the second electrode being spaced apart from the other surface of the first electrode.

The shield section may include a plurality of heat absorbing ridges protruding toward the fixing device.

The radiator section may include a plurality of heat radiating ridges protruding into an internal path of the suction duct.

The foregoing and/or other features and utilities of the present general inventive concept may also be achieved by providing an image forming apparatus including a main body defining an external appearance of the image forming apparatus, a developing unit placed within the main body to form a visible image on a printing medium using developer, and a blowing device configured to suction air from the developing unit and discharge the air to an outside of the main body, wherein the developing unit includes a photoconductor and a charging device to charge the photoconductor, and the blowing device is configured to suction discharge byproducts generated from the charging device and discharge the discharge byproducts to the outside of the main body.

The foregoing and/or other features and utilities of the present general inventive concept may also be achieved by providing an image forming apparatus including a developing unit to form a visible image on a printing medium using developer, a fixing device to fix the developer image to the printing medium, and a heat plate having one end disposed close to the fixing device to receive heat from the fixing device and the other end extended from the one end toward a position away from the fixing device and the developing unit such that the heat is discharged away from the fixing device and the developing unit through the other end of the heat plate.

The apparatus may further include a blowing device disposed to generate an air flow, and the heat plate may be disposed in the air flow for heat exchange.

The apparatus may further include a blowing device disposed to generate an air flow to discharge byproduct generated from the developing unit away from the developing unit and to cool the other end of the heat plate.

The fixing device may include a heating source and a fixing device housing to accommodate the heating source, and the heat plate may be disposed to receive the heat directly from the heating source or to receive the heat through the fixing device housing.

The apparatus may further include a main body having front and rear portions to accommodate the developing unit and the fixing device therebetween, a discharge portion to discharge the printing medium with the developed image in a discharge direction from the rear portion toward the front portion, and side portions disposed between the front portion and the rear portion. The heat of the heat plate may be discharged toward an outside of the main body through one of the side portions of the main body.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a schematic diagram illustrating an image forming apparatus according to an embodiment of the present general inventive concept;

FIG. 2 is a side view illustrating a developing unit, fixing device, and blowing device included in the image forming apparatus of FIG. 1 according to an embodiment of the present general inventive concept;

FIG. 3 is an exploded perspective view illustrating the developing unit and the blowing device included in the image forming apparatus of FIG. 1 according to an embodiment of the present general inventive concept; and

FIG. 4 is a perspective view illustrating the developing unit and the blowing device included in the image forming apparatus of FIG. 1 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

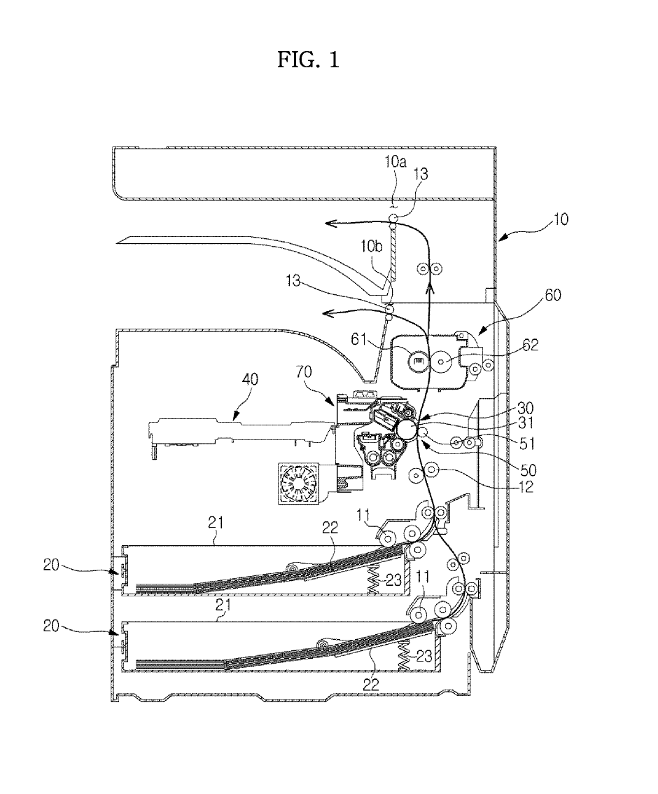

The image forming apparatus according to the embodiment of the present general inventive concept, as illustrated in FIG. 1, includes a main body 10 defining an external appearance thereof, a printing media supply unit 20 to supply printing media, a developing unit 30 to develop an electrostatic latent image into a mono or colored visible image using developer, an exposure unit 40 to form the electrostatic latent image by irradiating light to a photoconductor 31 of the charged developing unit 30, a transfer device 50 to transfer the visible image, i.e. developer image, formed on the photoconductor 31 of the developing unit 31, to a printing medium transmitted from the printing media supply unit 20, and a fixing device 60 to fix the transferred developer image (or developed image) to the printing medium.

The printing media supply unit 20 includes a printing media cassette 21 movably installed or detachably attached to the main body 10, a knock-up plate 22 placed in the printing media cassette 21 such that at least one printing medium is loaded on the knock-up plate 22, and an elastic member 23 configured to elastically support the knock-up plate 22. In the present embodiment, two printing media supply units 20 are arranged at upper and lower positions to supply different sizes of printing media.

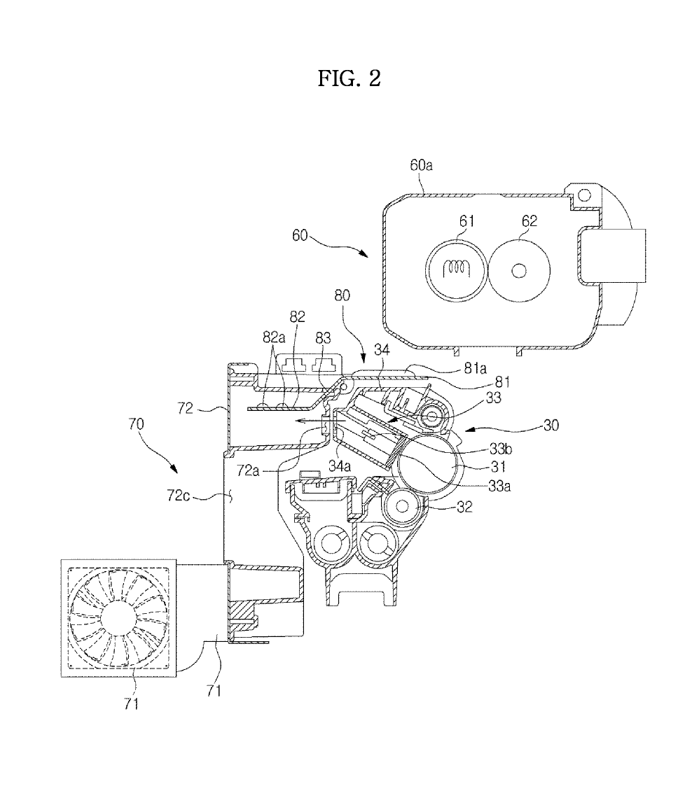

Referring to FIGS. 1 and 2, the developing unit 30 includes the photoconductor 31 on which the electrostatic latent image is formed by the exposure unit 40, a developing roller 32 to feed developer to the photoconductor 31, a charging device 33 to charge a surface of the photoconductor 31, and a developing housing 34 defining an external appearance of the developing unit 30 to accommodate the photoconductor 31, developing roller 32, and charging device 34 therein. Here, the charging device 33 may include a first electrode 33a having one surface to be spaced apart from the photoconductor 31 so as to face the photoconductor 31, the first electrode 33a having a lattice shape, and a second electrode 33b disposed to face the other surface of the first electrode 33a, the second electrode 33b having a pin shape. The surface of the photoconductor 31 is charged to a constant potential as corona discharge occurs between the first electrode 33a and the second electrode 33b.

The exposure unit 40 forms the electrostatic latent image on the surface of the photoconductor 31by irradiating light containing image information to the photoconductor 31 of the developing unit 30.

The transfer device 50 includes a transfer roller 51 to transfer the visible image formed on the photoconductor 31 to the printing medium.

The fixing device 60 includes a heating roller 61 to generate heat, and a pressure roller 62 having an outer peripheral surface formed of an elastically deformable material, the pressure roller 62 serving to press the printing medium against the outer peripheral surface of the heating roller 61. The fixing device 60 may include a fixing device housing 60a to accommodate the heating roller 61 and the pressure roller 62, to receive a printing medium to be fed along a path between the heating roller 61 and the pressure roller 62 and to discharge the printing medium with the fixed developer image. However, the present general inventive concept is not limited thereto. It is possible that the heating roller 61 and the pressure roller 62 can be installed in the main body without the fixing device housing 60a. It is also possible that the fixing device housing 60a may cover portions of the heating roller 61 and the pressure roller 62. It is also possible that the fixing device housing 60a may transmit heat generated from the heating roller 61 to an outside of the fixing device housing 60a.

The image forming apparatus may include a blowing device 70 to suction air from the developing unit 30 and expels discharge byproducts, such as ozone or nitrogen oxide, generated during an operation of the charging device 33 of the developing unit 30, from the main body 10 along with the air.

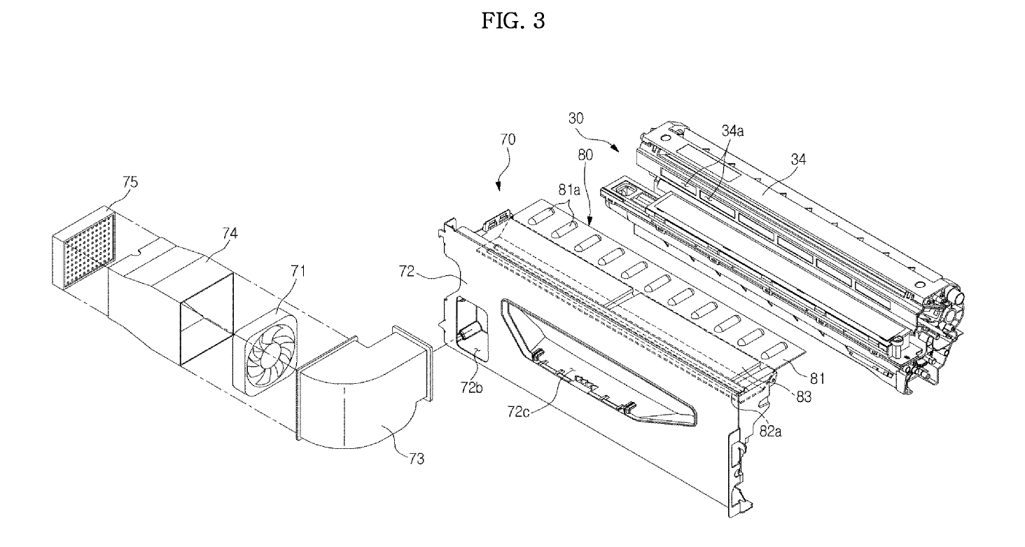

Referring to FIGS. 2 and 3, the blowing device 70 includes a blowing fan 71 to provide a force to suction and discharge air according to rotation of one or more fans by a fan motor thereof, a plurality of ducts including a suction duct 72, a connection duct 73, and a discharge duct 74, and a filter 75 provided at a portion of the blowing device 70, for example, at a distal end of the discharge duct 74 to filter the discharge byproducts. The suction duct 72 has a width equivalent to that of the developing unit 30 in a width direction perpendicular to a feeding direction of the printing medium, and internally defines an air path, into which the discharge byproducts generated by the charging device 33 are suctioned along with the air. One end of the connection duct 73 is connected to the suction duct 72, and the other end of the connection duct 73 is connected to the blowing fan 71, such that the discharge byproducts and air suctioned into the suction duct 72 are directed to the blowing fan 71 through the connection duct 73. The discharge duct 74 guides discharge of the discharge byproducts and air from the blowing fan 71 to the outside of the main body 10. Here, the suction duct 72 has a suction port 72a at a position corresponding to the charging device 33, and the developing housing 34 has a discharge port 34a at a position corresponding to the suction port 72a for discharge of the discharge byproducts. The above-described charging device 33 is located inside the developing housing 34 to communicate with the discharge port 34a of the developing housing 34. The suction duct 72 further has a communication hole 72b to which the connection duct 73 is connected, and a through-hole 72c to allow light irradiated from the exposure unit 40 to reach the photoconductor 31 of the developing unit 30 through the suction duct 72.

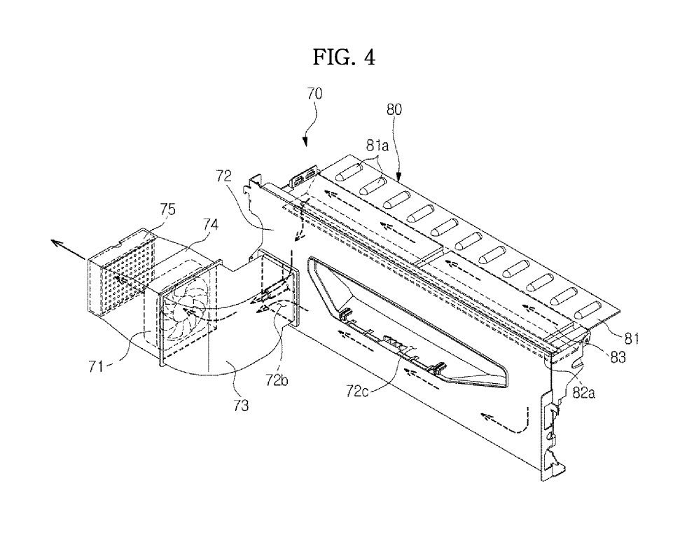

After the discharge byproducts generated by the charging device 33 are suctioned along with the air enter into the suction duct 72 through the discharge port 34a and the suction port 72a in an arrow direction of FIG. 2, the suctioned discharge byproducts move through the suction duct 72 to thereby be directed into the connection duct 73 connected to the communication hole 72b of the suction duct 72. Then, as illustrated in FIG. 4, as the discharge byproducts are suctioned into the blowing fan 71 connected to the connection duct 73 and pass through the discharge duct 74, the discharge byproducts are finally filtered by the filter 75 located at the distal end of the discharge duct 74.

Referring to FIG. 1, the main body 10 has one or more printing media discharge openings 10a and 10b, from which printing media on which images have completely been formed are discharged. Provided additionally within the main body 10 are pickup rollers 11 disposed above the printing media supply units 20 to pick up the printing media loaded on the knock-up plates 22, delivery rollers 12 to guide the printing media picked up by the pickup rollers 11 upward, and one or more discharge rollers 13 disposed above the fixing device 60 at positions close to one or more discharge openings 10a and 10b to discharge the printing media having passed through the fixing device 60 from the corresponding discharge openings 10a and 10b.

Referring to FIGS. 2, 3, and 4, the image forming apparatus further includes a heat plate 80 located between the developing unit 30 and the fixing device 60 to restrict transmission of heat from the fixing device 60 to the developing unit 30. The heat plate 80 is formed of a metal material for easy heat transmission. The heat plate 80 includes a shield section 81 located between a top of the developing unit 30 and a bottom of the fixing device 60 to absorb heat transmitted from the fixing device 60 to restrict transmission of heat to the developing unit 30, a radiator section 82 to integrally extend from the shield section 81 to be cooled via heat exchange with air, and a connecting section 83 to extend to connect the shield section 71 and the radiator section 82 to each other. The connecting section 83 may not be disposed on a straight line but be disposed along a curved or bent line direction or disposed obliquely to change or direct a flow direction of the air. The shield section 81 may be disposed to efficiently receive heat emitted from the fixing device 60. The shield section 81 may be disposed on a same side as the heating roller 61 with respect to a feeding path of the printing medium. The shield section 81 may have a width parallel to a rotation axis of the developing unit 30 or the fixing device 60. The width of the shield section 81 may be narrower than a width of the developing unit 30 or the fixing device 60. It is possible that the width of the shield section 81 may be narrower than a width of the photoconductor 31 of the developing unit 30 or the heating roller 61 of the fixing device 60. The shield section 81 may be disposed on a portion of the developing housing 34, may be formed as a portion of the developing housing 34, or may extend or protrude from a portion of the developing housing 34 toward the feeding path of the printing medium.

In the present embodiment, the radiator section 82 of the heat plate 80 is located within the suction duct 72 to ensure more rapid radiation of heat, thereby being cooled via heat exchange with air passing through the suction duct 72. That is, the blowing device 70 serves not only to discharge the discharge byproducts generated by the charging device 33 to the outside of the main body 10, but also to cool the heat plate 80 so as to restrict transmission of heat from the fixing device 60 to the developing unit 30.

When heat is transmitted from the fixing device 60 to the developing unit 30, a large part of the heat is absorbed by the shield section 81 of the heat plate 80. After the heat is transmitted to the radiator section 82 placed within the suction duct 72 through the connecting section 83, the heat is absorbed by the air passing through the suction duct 72, thereby being discharged outward from the main body 10 by sequentially passing through the connection duct 73, blowing fan 71, and discharge duct 74. As such, transmission of heat from the fixing device 60 to the developing unit 30 is restricted by the heat plate 80, which assists the developing unit 30 in remaining below a predetermined temperature, and prevents decomposition of developer within the developing unit 30.

The shield section 81 of the heat plate 80 is provided with a plurality of heat absorbing ridges 81a to increase a heat exchange area. The heat absorbing ridges 81a integrally protrude from a major surface of the shield section 81 toward the fixing device 60 to ensure easy absorption of heat from the fixing device 60. Also, the radiator section 82 is provided with a plurality of heat radiating ridges 82a to increase a heat exchange area. The heat radiating ridges 82a integrally protrude from a major surface the radiator section 82 to be disposed in the internal path of the suction duct 72 to provide a more efficient cooling effect to the radiator section 82 via heat exchange with the air passing through the suction duct 72.

Although the present embodiment describes the connecting section 83 as being present between the shield section 81 and the radiator section 82 for convenience of description, the present general inventive concept is not limited thereto. It is possible that the shield section 81 and the radiator section 82 are directly connected to each other.

As is apparent from the above description, according to the embodiments of the present invention, providing a heat plate between a fixing device and a developing unit to absorb heat to be transmitted from the fixing device to the developing unit may prevent heat generated from the fixing device from being transmitted to the developing unit.

Further, as described above, providing a blowing device to suction and filter discharge byproducts generated by a charging device may ensure outward discharge of corona-discharge byproducts from a main body of an image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a developing unit to form a visible image on a printing medium using developer;
a fixing device to fix the developer image to the printing medium; and
a heat plate placed between the developing unit and the fixing device.

2. The apparatus according to claim 1, wherein the heat plate includes a shield section located between the developing unit and the fixing device, and a radiator section integrally extending from the shield section, the radiator section being cooled via heat exchange with air.

3. The apparatus according to claim 2, wherein the heat plate further includes a connecting section to connect the shield section and the radiator section to each other.

4. The apparatus according to claim 2, further comprising:
a blowing device to allow the radiator section to be cooled in contact with air.

5. The apparatus according to claim 4, further comprising:
a main body defining an external appearance of the image forming apparatus,
wherein the blowing device includes a blowing fan, a suction duct having a width equivalent to a width of the developing unit, into which air is suctioned from the developing unit, a connection duct to connect the suction duct and the blowing fan to each other, and a discharge duct to guide the air discharged from the blowing fan to an outside of the main body.

6. The apparatus according to claim 5, wherein the radiator section is located within the suction duct and is cooled by the air passing through the suction duct.

7. The apparatus according to claim 5, wherein:
the developing unit includes a photoconductor and a charging device to charge the photoconductor; and
the blowing device is configured to suction discharge byproducts generated from the charging device and discharge the discharge byproducts to the outside of the main body.

8. The apparatus according to claim 7, wherein:
the suction duct has a suction port at a position corresponding to the charging device; and
the developing unit includes a developing housing provided with a discharge port at a position corresponding to the suction port, and the charging device is located inside the discharge port of the developing housing.

9. The apparatus according to claim 8, wherein the charging device includes a first electrode having a lattice shape, one surface of the first electrode being spaced apart from the photoconductor so as to face the photoconductor, and a second electrode having a pin shape, the second electrode being spaced apart from the other surface of the first electrode.

10. The apparatus according to claim 2, wherein the shield section includes a plurality of heat absorbing ridges protruding toward the fixing device.

11. The apparatus according to claim 2, wherein the radiator section includes a plurality of heat radiating ridges protruding into an internal path of the suction duct.

12. An image forming apparatus comprising:
a main body defining an external appearance of the image forming apparatus;
a developing unit placed within the main body and serving to form a visible image on a printing medium using developer; and
a blowing device configured to suction air from the developing unit and to discharge the air to an outside of the main body,
wherein the developing unit includes a photoconductor and a charging device to charge the photoconductor, and
wherein the blowing device is configured to suction discharge byproducts generated from the charging device and discharge the discharge byproducts to the outside of the main body.

13. The apparatus according to claim 12, wherein:
the blowing device includes a blowing fan, a suction duct having a suction port corresponding to the charging device and configured to suction the air from the charging device, a connection duct to connect the suction duct and the blowing fan to each other, and a discharge duct to guide the air discharged from the blowing fan to the outside of the main body; and
the developing unit includes a developing housing provided with a discharge port at a position corresponding to the suction port, and the charging device is located inside the discharge port of the developing housing.

14. The apparatus according to claim 12, wherein the charging device includes a first electrode having a lattice shape, one surface of the first electrode being spaced apart from the photoconductor so as to face the photoconductor, and a second electrode having a pin shape, the second electrode being spaced apart from the other surface of the first electrode.

15. The apparatus according to claim 12, further comprising:
a fixing device to fix the developer to the printing medium; and
a heat plate placed between the developing unit and the fixing device,
wherein the head plate includes a shield section located between the developing unit and the fixing device, and a radiator section integrally extending from the shield section, the radiator section being cooled via heat exchange with air.

16. An image forming apparatus comprising:
a developing unit to form a visible image on a printing medium using developer;
a fixing device to fix the developer image to the printing medium; and
a heat plate having one end disposed close to the fixing device to receive heat from the fixing device and the other end extended from the one end toward a position away from the fixing device and the developing unit such that the heat is discharged away from the fixing device and the developing unit through the other end of the heat plate.

17. The apparatus of claim 16, further comprising:
a blowing device disposed to generate an air flow,
wherein the heat plate is disposed in the air flow for heat exchange.

18. The apparatus of claim 16, further comprising:
a blowing device disposed to generate an air flow to discharge byproduct generated from the developing unit away from the developing unit and to cool the other end of the heat plate.

19. The apparatus of claim 16, wherein:
the fixing device comprises a heating source and a fixing device housing to accommodate the heating source; and
the heat plate is disposed to receive the heat directly from the heating source or to receive the heat through the fixing device housing.

20. The apparatus of claim 16, further comprising:
a main body having front and rear portions to accommodate the developing unit and the fixing device therebetween, a discharge portion to discharge the printing medium with the developed image in a discharge direction from the rear portion toward the front portion, and side portions disposed between the front portion and the rear portion,
wherein the heat of the heat plate is discharged toward an outside of the main body through one of the side portions of the main body.
